(19) United States
(12) Patent Application Publication
(10) Pub. No.: US 2011/0037695 A1
(43) Pub. Date: Feb. 17, 2011

(54) ERGONOMIC CONTROL UNIT FOR PROVIDING A POINTING FUNCTION

(76) Inventors: Igal BOR, Ramat-Gan (IL); Tal Or, Tel Aviv (IL); Nechemia Bor, Jerusalem (IL)

Correspondence Address: EDWARD LANGER;c/o SHIBOLETH YISRAELI ROBERTS ZISMAN & CO., 1 PENN PLAZA-SUITE 2527, NEW YORK, NY, 10119, US

(21) Appl. No.: 12/541,951

(22) Filed: Aug. 16, 2009

(51) Int. Cl. G06F 3/033

(52) U.S. Cl. 345/158

(57) ABSTRACT

A control unit disposed in a remote-control pointing device for providing a control and pointing function. The control unit comprises a stationary element, a movable control element with a reflective surface disposed proximate to the stationary element, at least one optical sensor fixedly disposed in close proximity to the movable control element, and at least one pressure sensor. When the optical sensor is activated by movement of the movable control element and when the movable control element is put into pressure contact with the pressure sensor, location and pressure contact data, respectively, are collected by the control unit enabling control and pointing functions associated with the pointing device without the need for an external, stationary reference surface.

### FIELD OF THE INVENTION

The present invention generally relates to the field of portable, hand-held, remote-control pointing devices for pointing and generating information pertaining to a target location, and more particularly, to an ergonomic control unit incorporated in such a remote-control pointing device for providing a multi-application pointing function without the need for a stationary, external reference surface.

### BACKGROUND OF THE INVENTION

Existing hand-held, remote-control, pointing devices (hereinafter, “pointing devices”)—such as a computer mouse for moving a cursor on a display screen or for performing specific computer operations and a remote-control for operating and guiding electro-mechanical equipment or devices—are used not only for pointing to a target location, but optionally for generating information pertaining to the target location and for controlling various modes of operation.

These kinds of pointing devices are generally equipped with optical motion sensors for recognizing relative movement initiated by a user on the pointing device and translating it into directed movement at a remote target location, such as movement of a cursor on a display screen.

For example, a typical cursor pointing device as used in conjunction with computer screens in stationary computer systems is operated by moving a small “mouse” over a flat, fixed surface using an optical sensor to monitor the relative direction and speed of motion of the mouse in relation to the flat, fixed surface and emulating such activity on-screen. The mouse communicates the speed and position data to a computer by a wire connection or a wireless communication system. The mouse itself typically has “right” and “left” click buttons operable by finger pressure for implementing specific computer commands and a scrolling wheel for moving rapidly up and down on screen between pages or lines of text and/or graphics.

A major disadvantage of this type of pointing device is clearly its need to be operated on a flat, fixed surface, usually with a mouse pad. Various solutions replace the mouse and mouse-pad altogether, especially in laptop computers which are conventionally provided with a multi-directional touch controller added to the keyboard, or other solutions such as a track-ball, pointing stick, air-mouse, or joystick simulator. Even so, the great majority of workstations (and also, as an add-on option, many laptop computers) nevertheless still rely on a mouse pointer moved over a flat, fixed surface external to the mouse pointer.

Recent developments in technology, such as 3D virtual reality controllers, music synthesizers, and game controllers are now utilizing hand—or wrist—gestures recognized by motion detectors used in conjunction with image processing hardware. These solutions, aside from being expensive because they are specialized, primarily rely on interpretation of images generated by broad hand-gestures rather than pointing functions generated by a mouse. Because more and more remote screens are used at home, at school, and at work it is becoming clear that such a broad control function is unsuitable in many applications where finer control movements are required to carry out these pointing functions.

The information on the location of the pointing device and its relative movement is digitized and translated by an algorithm into location and movement data on a target element, such as the location and speed and direction of motion of a cursor on a display screen. Most prior art devices also enable sending commands and receiving indications. For example, this can be done by signals generated from activating push buttons on the device or by selection of commands from pull-down menus shown on a display screen, such as that on a computer monitor, art iPod, Personal Digital Assistant, cellular phone, and many hand-held, remote-control pointer devices for operating electro-mechanical devices such as an air conditioning unit, a TV, and the like.

The prior art includes available products related to devices whereby a relative move of a pointing device or a movable element thereof is measured with respect to a stationary surface, such as a touch screen, or a tablet that is not part of the pointing device. Non-movable movement tracking elements include a touching surface, e.g., as part of a personal computer upon which a user moves his finger on the surface. Another example is a joystick which is rotated on its axis by a user. A sensor underneath the surface or in the joystick tracks the movement. There are mechanical and optical computer mouse devices employing infra-red or laser sensors, such as the Logitech® mouse. These latter type devices operate by generating accurate data in a timely manner (fast response time). Most such devices function by moving the pointing device itself while in direct contact with or in close proximity to a well-defined, limited area, such as a dry, flat surface.

Handheld devices that do not need a close-by surface reference are generally based on an infrared beam or RF signals sent to an object (e.g., a sensor on a TV monitor) and receive some kind of feedback. They are less accurate and harder to use (a user needs to hold the device in the proper orientation in order for the de vice to receive feedback). Other handheld devices, such as, for example, a Nintendo WII 3D® remote control which needs to be used by a user's hand held up in the air, are not accurate enough for use as a computer mouse and have limited application. In order to use them in conjunction with computer display screens, they were enhanced with expensive feedback and a menu mechanism so as to reveal special buttons on the target display screen. Standard remote controls for electronic devices use a confusing array of buttons to send a variety of signals to indicate different modes of operation at the target element location.

Other types of controller devices, similar to a pointing device, are cellular phone devices which can be used to connect to other digital devices. Due to the fact that more and more cellular phones have also moved into providing Internet services using graphic display screens and text features such as SMS, they also require pointing capabilities for navigation and control, but they suffer the disadvantage of having relatively small screens due to the limitations of the size of their housing.

It should be noted that some smaller display screens often require the use of a stylus in conjunction with a touch-screen for finer, precise operation of menu-driven programs, since even activation by use of a mouse tends to be too broad given the physical scale of these devices.

Although the use of remote screens in many applications and across many platforms has increased many times over as a result of rapid product development, the state of the art of remote control pointing devices has not kept pace with it. For example, in many cellular applications, fine movement may be required, but cursor controls for cellular devices generally lack fine movement suitable for use with their small-sized screens. Generally, cellular devices use multiple pop-up screens which are selected to activate specific features and/or they are provided with special purpose keys or buttons which are finger-operated. In some cases, a stylus is provided to mark on-screen selections within a very small menu.

Use of a stylus and or light finger pressure on touch-type screens is an inefficient and inaccurate mode of operation for making fine movements for a pointer device. Slow or fast modes of movement (in navigating the reduced-size imagery and text provided by a mobile device) are seldom provided for. This is problematic when, for example, fine movements might be required, such as for navigating within web pages or playing online games with speed and dexterity.

Most hand-held remote-control pointing devices for operating electronic devices, such as TV and entertainment systems, air conditioners, heating units, garage and door openers, and the like each require an expensive, specialized unit with finger-operated push-buttons, sometimes configured in different arrays and provided with a variety of specialized symbols and often these are not intuitive. Aside from the expense involved either in the manufacture or acquisition of each new pointing device for every new, remote-controlled appliance purchased, a user must spend time learning the new sophisticated system of buttons and their often esoteric symbols for operation. Furthermore, the fact that some pointing devices need to be operated in conjunction with a fixed, planar surface, limits their usefulness for other applications.

In many situations it is desirable to have a single, handheld, pointing device without the need for reference to an anchored element (in order to measure a relative motion) and that is operable under many environments and in different applications. Prior art, hand-held, remote-control pointing devices all suffer from one or more of the disadvantages described above.

Thus there is a need for an inexpensive, universal, portable, hand-held, remote-control pointing device incorporating a control unit having a movable control element which provides, with intuitive ergonomic manipulation, a multi-application pointing function for pointing and generating information pertaining to a target location without the need for a stationary reference surface.

### SUMMARY OF THE INVENTION

Accordingly, it is a broad object of the present invention to overcome the above disadvantages and limitations of the prior art by providing a novel control unit incorporated into a remote-control pointing device.

Another object of the invention is to provide a control unit having a movable control element which does not need a reference to an external anchored element in order to measure relative motion of the movable control element.

A further object of the invention is to provide a control unit containing an ergonomic, movable control element operable by finger manipulation, and designed to be intuitive for a pointing function.

Still another object of the invention is to provide a control unit integrating pressure sensors synchronized with optical sensors so as to enhance pointing functions as well as control and command capabilities. The latter includes enabling selection of control for speed and direction, and resolution of coarse, rough movements; large movements; and fine movements, all in one device.

Yet another object of the invention is to provide navigational and command functions within a control unit of a remote-control pointing device using simple, inexpensive components.

For the sake of illustration, a computer mouse is used as a generic example of a common pointing device in the summary and description of the present invention which follows, although it should be understood by those skilled in the art that this is not meant as a limitation, but that other types of pointing devices are also intended to be included in the concept of the present invention as described and claimed hereinafter.

In accordance with the present invention, there is provided a control unit disposed in a portable, hand-held, remote-control pointing device for providing a control and pointing function, the control unit comprising:

a stationary element;

a movable control element having at least one reflective surface disposed proximate to the stationary element and arranged for motion with respect thereto for activating the control and pointing function;

at least one optical sensor fixedly disposed in close proximity to the movable control element to acquire location data by tracking relative motion with respect to the at least one reflective surface; and at least one pressure sensor fixedly disposed in close proximity to the movable control element to detect pressure contact therewith and to collect associated contact data,
such that when the control unit is connected to a power source and operated and the movable control element is put into motion by a user, the at least one optical sensor detects movement of and collects location data with respect to the at least one reflective surface; and the at least one pressure sensor detects pressure contact when the movable control element is put into pressure contact therewith and collects the contact data; the location data and the pressure contact data enabling control and pointing functions associated with the pointing device without the need for an external, stationary reference surface.

The present invention comprises a novel control unit integrated with a remote-control pointing device. This is instead of the conventional mouse that is based on movement of a (optical/laser) position sensor with respect to a static or fixed surface. The present invention features integration of a position sensor for determining the relative motion of a movable control element with respect to the stationary position of an optical/laser sensor for purposes of directing a cursor, for example, on a computer screen.

The present invention further comprises a unique, user-friendly, multi-purpose, remote-control pointing device which features integration of an optical sensor with at least one pressure sensor, e.g. a piezoelectric type, for determining the relative motion of a movable control element in relation to a reference surface not anchored to a fixed surface while providing several modes of pointer operation from fine to coarse and at different speeds.

In an exemplary embodiment of the present invention, the pressure sensors are disposed alongside the frame bordering the control unit. The movable control element can be pressed against the pressure sensors to activate them. The pressure sensors control both the continuous direction and speed of movement of a cursor on a display screen.

The direction of the movement is achieved by the combination of the control provided by one or more pressure sensors which are contacted by a portion of the movable control element (a curved surface—such as a ring, ball, or sphere a flat disk, or any combination of these). Movement is enabled in three dimensions (x, y, and z). The integration of at least one pressure sensor with the movable control element enables the ability to get both coarse, rapid movements and fine movements in one device to serve for many applications where choosing various menu options, such as cursor control and control of navigation, is required.

Another optional application or feature of the remote-control pointing device is that a switch can be used for selecting the host (such as PC/TV/cellular phone), changing the static speed mode, and/or adjusting the resolution mode—either fine movement or coarse movement. In a preferred embodiment of the present invention, the switch is a simple toggle switch.

All of the design of this pointing device is in the context (but not only) of an ergonomic hand-held device which is easy to manipulate with the fingers for achieving all of these different kinds of motions and resolution levels.

In an exemplary embodiment of the present invention, the movable element is a cylindrical, curved surface, such as a ring, whose inner reflective surface serves as a motion reference in relation to a stationary inner cylindrical tube. In one embodiment, an internally disposed optical sensor is mounted on a base within the circumference of the ring and “looks” at the inside reflective surface of the ring as it slides and/or rotates on the cylindrical tube.

Alternatively, an optical sensor is disposed externally to the movable ring control element, and detects any motion of an exterior reflective surface when the ring is rotated or slid on the relatively stationary cylindrical tube. In all cases, the location sensor(s) is stationary and the reference surface is moved.

Another feature that is important for control of the cursor movement, or the pointing movement of the present invention is the ability to control direction and coarse, rough movements; large movements; and fine movements. For this purpose, in one embodiment of the present invention, at least one pressure sensor is integrated with an optical sensor into the device to interact with the movable element.

The movable control element, such as a ring, makes contact with a partial or complete frame border housing a pressure sensor which, when activated by contact with the movable control element, provides information which is used by the system to enable a rapid or slow movement of a cursor in accordance with the pressure applied. Once the rapid-movement cursor mode is achieved, the pressure applied to the sensor is released and the relative motion is again controlled by the optical sensor which detects the relative motion of the reflective surface of the movable control element. The movable control element can be any kind, but in a preferred embodiment of the present invention, the movable control element is a ring. Alternatively, a flat disk with a central knob, or a rectangular base with a knob, comprises the movable control element.

In order to achieve a distinction between slow movements and rapid movements in a movable control element, such as in the case of the ring embodiment of the present invention, the optical sensor, when activated, detects and causes the movement of a cursor to go into a different speed mode. For example, if a quick, jerk-type motion of the ring is initiated, one gets a much quicker motion of the cursor on a display screen for a certain portion of time, and then, when the motion of the ring is slowed, the outcome is finer control of the cursor on the screen.

The integration of at least one pressure sensor with at least one optical sensor in a system using the control unit of the present invention in a hand-held pointing device enables both coarse and fine movements in one, ergonomic, multi-purpose device which is intuitive to use and easy to manipulate with the fingers for achieving all these different kinds of motions and resolution levels.

Other features and advantages of the invention will become apparent from the drawings and the description given below.

### BRIEF DESCRIPTION OF THE DRAWINGS

For a better understanding of the invention with regard to the embodiments thereof, reference is made to the accompanying drawings, not to scale, in which like numerals designate corresponding elements or sections throughout and wherein

FIG. 1 shows a general view of an exemplary embodiment of the present invention incorporated within a pointing device;

FIGS. 2A and 2B show detailed exploded views of the movable ring element of FIG. 1 in relation to an internally mounted sensor unit;

FIG. 3A shows a cut-away and exploded view of another embodiment of the present invention provided with additional pressure sensors and at least one internal optical sensor;

FIG. 3B shows a view of the assembled control unit from FIG. 3A in relation to spaced-apart pressure sensors;

FIG. 4A depicts an assembled view of an alternate embodiment of a control unit of the present invention operable in conjunction with a single pressure sensor;

FIG. 4B is an exploded view of the embodiment of the present invention of FIG. 4A showing details of the assembly;

FIG. 5 is a perspective view of another embodiment of a control unit of the present invention shown in relation to an externally mounted optical sensor;

FIG. 6 is a perspective view of another embodiment of the present invention shown incorporated into a conventional remote-control pointing device;

FIG. 7A shows a top surface perspective view of the control unit of FIG. 6;

FIG. 7B shows a bottom perspective view of the control unit of FIG. 7A;

FIG. 8 shows a general perspective view of yet another embodiment of a control unit constructed in accordance with the principles of the present invention, comprising a movable flat disk with a finger-operated knob, shown incorporated into a conventional remote-control pointing device;

FIGS. 9A and 9B are detailed illustrations of the finger operation of the control unit from FIG. 8;

FIG. 10 is a detailed exploded view showing the components of the flat disk embodiment of the control unit from FIGS. 9A and 9B;

FIGS. 11A and 11B show yet another embodiment of the present invention utilizing a control unit having a sliding control element and a slidable-knob for controlling pointing functions in a remote target location; and

FIG. 12 is a block diagram of the general system of the present invention in accordance with the principles thereof.

### DETAILED DESCRIPTION OF EXEMPLARY EMBODIMENTS

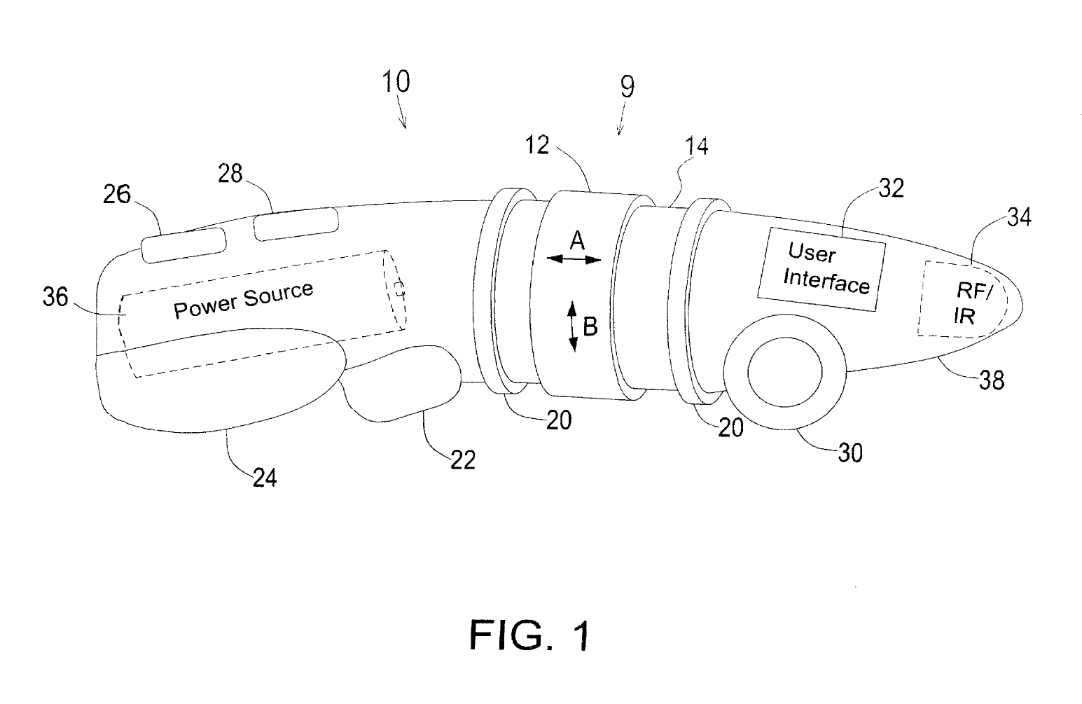

Referring now to FIG. 1, there is shown a general view of an exemplary embodiment of the present invention incorporated within a pointing device.

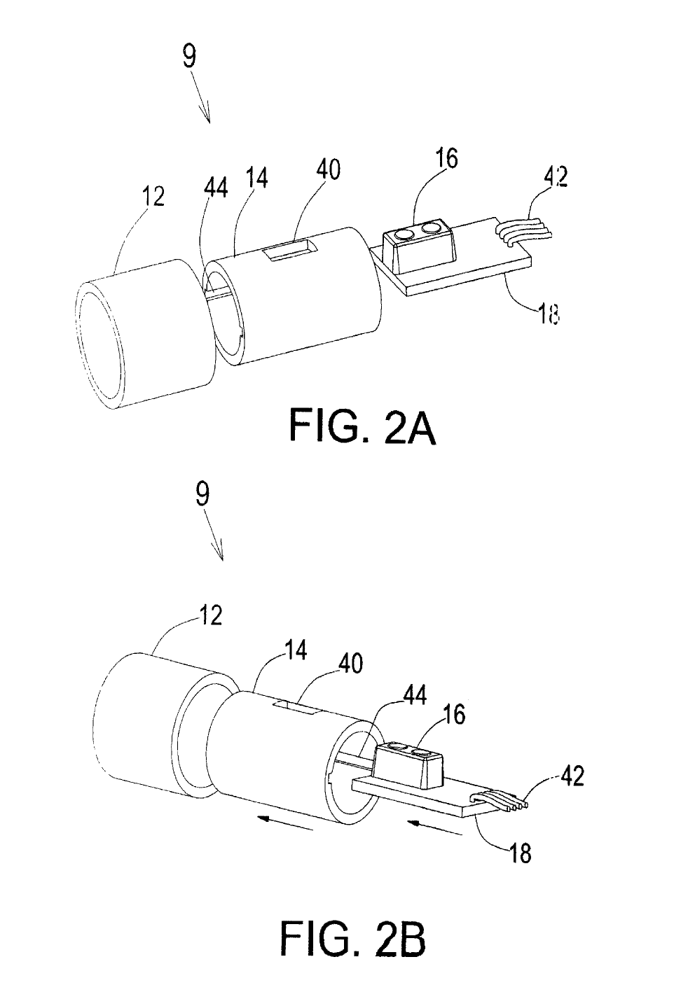

The hand-held, remote-control pointing device 10 incorporates a control unit 9, comprising a ring element 12 which is rotatable (arrow B) and slidable (arrow A) about a stationary cylindrical tube 14 anchored within the body 38 of pointing device 10. There is provided at least one, internally mounted, optical sensor 16 (see FIGS. 2A/2B for details). Two pressure sensors 20 are disposed, one at each limit of the sliding motion (indicated by arrow A) of ring element 12. Optionally, ring element 12 has an indentation formed in its outer surface to accommodate a human thumb or any other finger that is capable of manipulating it to rotate or slide.

Each pressure sensor 20 limits the axial movement of ring element 12 along the axis of device 10 in either direction (as shown by arrow A). These pressure sensors 20 provide control functions to pointer device 10. For example, when sliding ring element 12 presses against either pressure sensor 20, this operates a function of controlled, rapid movement of the cursor, depending on the amount of pressure applied. Pressing against either pressure sensor 20 while rotating ring element 12 when the cursor onscreen has reached the window boundaries can serve to move “page up” or “page down” in rapid scrolling to view a new, onscreen display of an adjacent “page” depending on the direction of sliding (arrow A).

The combination of rotational movement (arrow B) and sliding axial movement (arrow A) of ring element 12 allows for multi-directional navigation control for computer-generated pointers, such as for a cursor over the full area of a display screen. “Left” and “right” finger-operated buttons 22 and 24, serve the same function as the left and right buttons on a computer mouse. Additional control buttons using micro-switches and the like can optionally be added to body 38 of pointing device 10, capable of operating predetermined operations on the target computer.

In an exemplary embodiment of the present invention, functions include a device selection switch 26, and a pressure resolution and speed selection switch 28. These functions are optionally combined using a multiple-selection micro-switch to conserve space on the body of device 10. A scrolling wheel 30 is optionally provided for standard scrolling operations as on a computer display screen.

Another common feature optionally added to device 10 is a user interface 32, such as an alpha-numeric keypad or a touch screen for operating predetermined functions with human fingers. A radio frequency (RF) or infrared (IR) data transmitter 34 communicates with a remote target device within the limits of the range for operation of pointing device 10. Alternatively, sensed location data is transmitted to a target location, such as a computer display screen (not shown) by wire or wireless connections, such as Bluetooth, USB, and other technologies as are known to those skilled in the art.

In an exemplary embodiment of the present invention, a portable power source 36 is housed within a distal end of device 10. Preferably the power source 36 is a battery unit, but a rechargeable battery, or provision for connection to a fixed external power source, may optionally be provided.

FIGS. 2A and 2B show detailed exploded views of the control unit 9 of FIG. 1.

FIG. 2A shows a detailed exploded view of an exemplary embodiment of the present invention comprising a movable ring element 12 which is mounted over cylindrical tube 14 having an aperture 40 to accommodate the field of vision of a conventional optical sensor 16 which is fixedly mounted within grooves or slots 44 formed in the inside surface of cylindrical tube 14. Optical sensor 16 is mounted on a slide-in base 18 and connectable by cables 42 to a power supply 36 (see FIG. 1) and a central processing unit (not shown).

Optionally optical sensor 16 may also comprise a mechanical, radio, or laser-based location sensor and the like as are known to those skilled in the art. Optical sensor 16 measures the relative movement of movable ring element 12 with respect to stationary cylindrical tube 14. Alternatively, part of the surface of cylindrical tube 14 may be made of optically transparent material to facilitate the operation of an optical sensor instead of providing aperture 40. Furthermore, the material of the inside surface of movable ring element 12 is formed with a friction-enhanced coating to facilitate reflection and tracking of the relative motion of movable ring element 12 by optical sensor 16. The reflective inside surface serves as a dragging surface while reflecting the transmitted beam of optical sensor 16.

Movable ring element 12 is fully rotatable over cylindrical tube 14 and also slides in either direction along the axis of cylindrical tube 14 so as to provide two dimensions of motion (radial and axial, respectively). The position between movable ring element 12 and cylindrical tube 14 is monitored by optical sensor 16 which detects the relative position of each in respect to the other through aperture 40 (or a transparent portion of cylindrical tube 14) and transmits this information via a transmitter 34 (see FIG. 1) to a target device, such as a computer (not shown), for manipulation of a virtual pointer, such as a cursor on a computer display screen (not shown).

FIG. 2B shows how base 18 is secured into position by sliding into grooves 44 provided on the inside surface of cylindrical tube 14 so that optical sensor 16 is positioned directly under aperture 40 and is thus enabled to “see” the inside surface of movable ring 12 through aperture 40 when cylindrical tube 14 is inserted into ring element 12 (as shown by a second arrow).

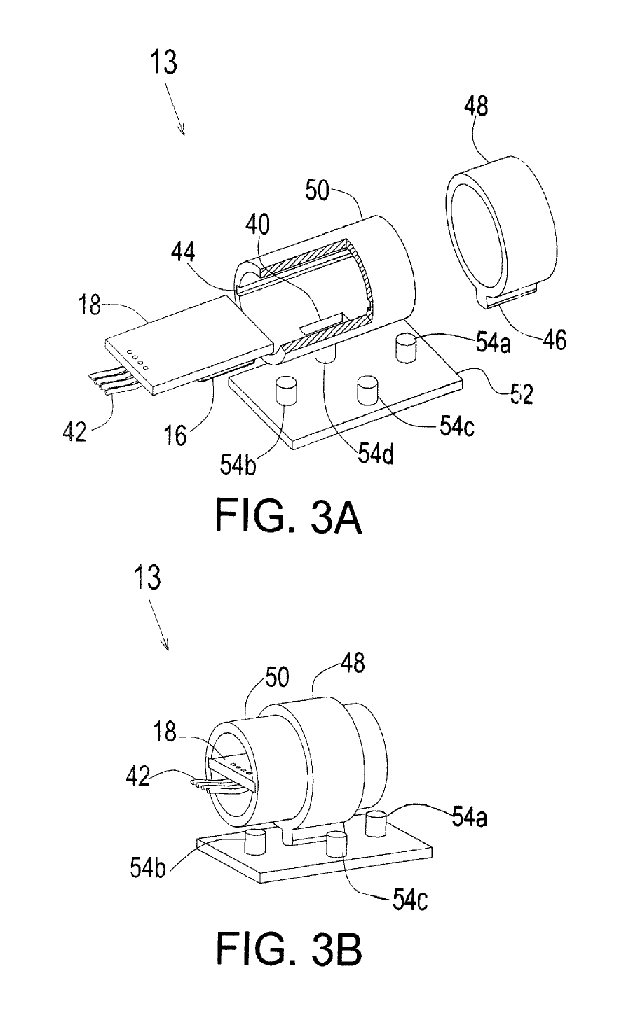

FIG. 3A shows an exploded, cut-away view of another embodiment of the present invention. Movable control unit 13 is oriented in close proximity with pressure sensors 54a/b/c/d which are fixed on a supporting base 52. At least one internally mounted optical sensor 16 is mounted on base 18 slidable into grooves 44 formed inside cylindrical tube 50 so as to be stationary relative to the movements of ring element 48. The stopper 46 formed on ring element 48 makes pressure contact with pressure sensors 54c and 54d when the ring element 48 is rotated from side to side to the limits defined by the pressure sensors 54c and 54d. When ring element 48 is slid to move over cylindrical tube 50 so as to make pressure contact with either pressure sensor 54a or 54b, other, predetermined control and pointing functions are activated.

In operation, the optical sensor 16 mounted on base 18 within cylindrical tube 50 “sees” the motion of ring element 48 through an aperture 40 and transmits this information via cables 42 (or wires) to a central processor (not shown) which can then control and navigate the movement of a cursor onscreen.

FIG. 3B is a view of the assembled control unit 13 of FIG. 3A showing the placement of ring 48 in relation to the spaced-apart pressure sensors 54a/b/c/d.

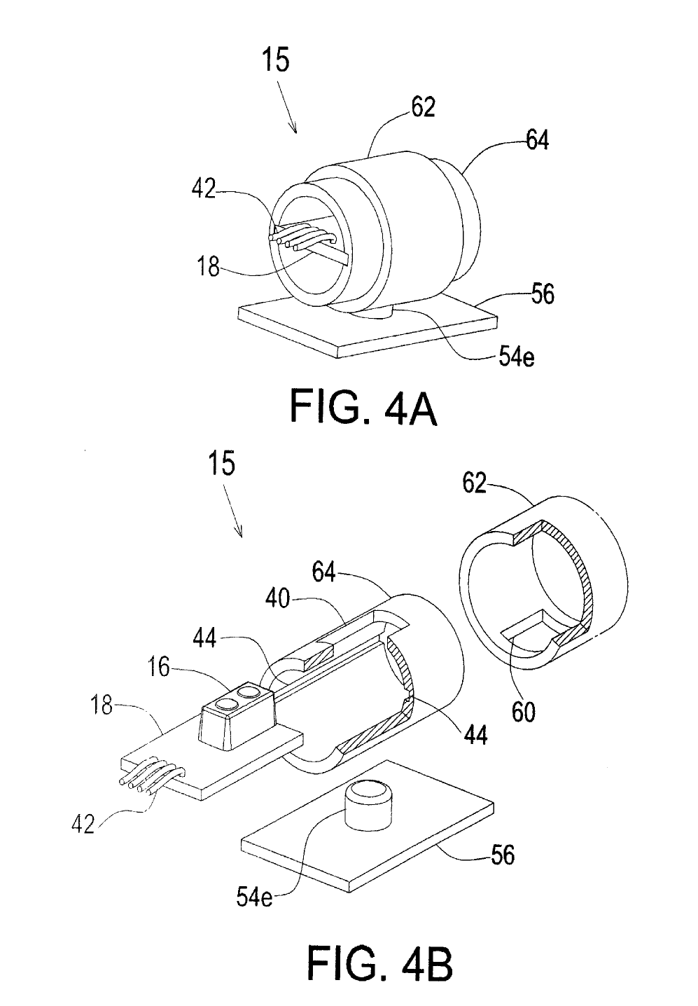

FIG. 4A depicts an assembled view of an alternate embodiment of a control unit 15 operable in conjunction with a single pressure sensor 54e. Pressure sensor 54e is disposed on a base 56. Ring element 62 is movably mounted over cylindrical tube 64, both of which are provided with apertures 58 and 60 (see FIG. 4B) to allow partial insertion of pressure sensor 54e so that movement of ring element 62 to the limits defined by the dimensions of aperture 60, cause the edge openings of aperture 60 to come into pressure contact with pressure sensor 54e to activate a control pointing function in accordance with the principles of the present invention.

FIG. 4B is an exploded view of the embodiment of FIG. 4A showing details of the assembly. In addition to pressure sensor 54e, optical sensor 16 is able to detect the movement of inner reflective surface of ring element 62 from within cylindrical tube 64 via another aperture 40 formed in an upper portion of cylindrical tube 64. The sensory data from pressure sensor 54e and optical sensor 16 is transmitted by cable 42 (or wires) or wireless transmission (via an RF or IR transmission module 34—see FIG. 1) to a central processing unit (not shown) where guidance is provided for movement of an onscreen cursor or operation and control of other pointing functions.

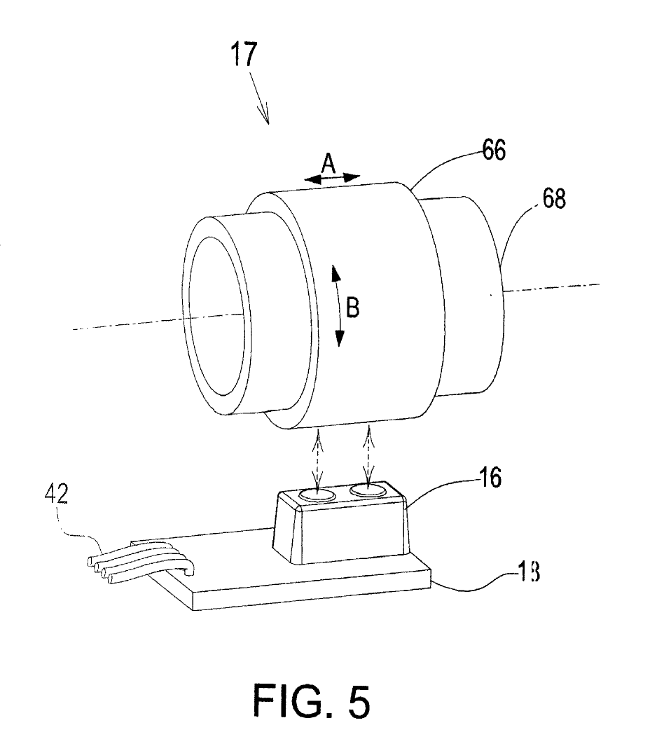

FIG. 5 is a perspective view of another embodiment of a control unit 17 constructed in accordance with the principles of the present invention and shown in relation to an externally mounted optical sensor.

Control unit 17 is shown disposed in close proximity to an externally disposed optical sensor 16 which can “see” the movement of the outer reflective surface of ring element 66 when slid axially in either direction as indicated by arrow A. Ring element 66 is also rotatable (shown by arrow B) around the common axis that it shares with cylinder tube 68, which is stationary. The relative position and movement of ring element 66 is communicated to a central processing unit (CPU) (not shown) in synchronization with other data such as from one or more pressure sensors (not shown) to guide and control the movement of a cursor onscreen and perform other predetermined pointing and control functions.

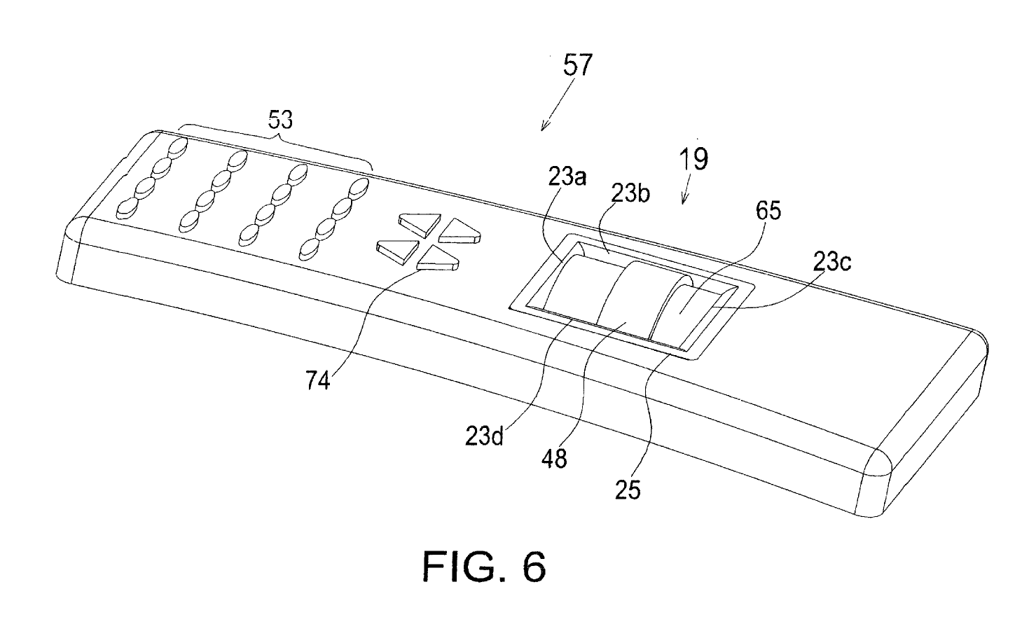

FIG. 6 is a perspective view of another embodiment of the present invention shown incorporated into a conventional remote-control pointing device 57.

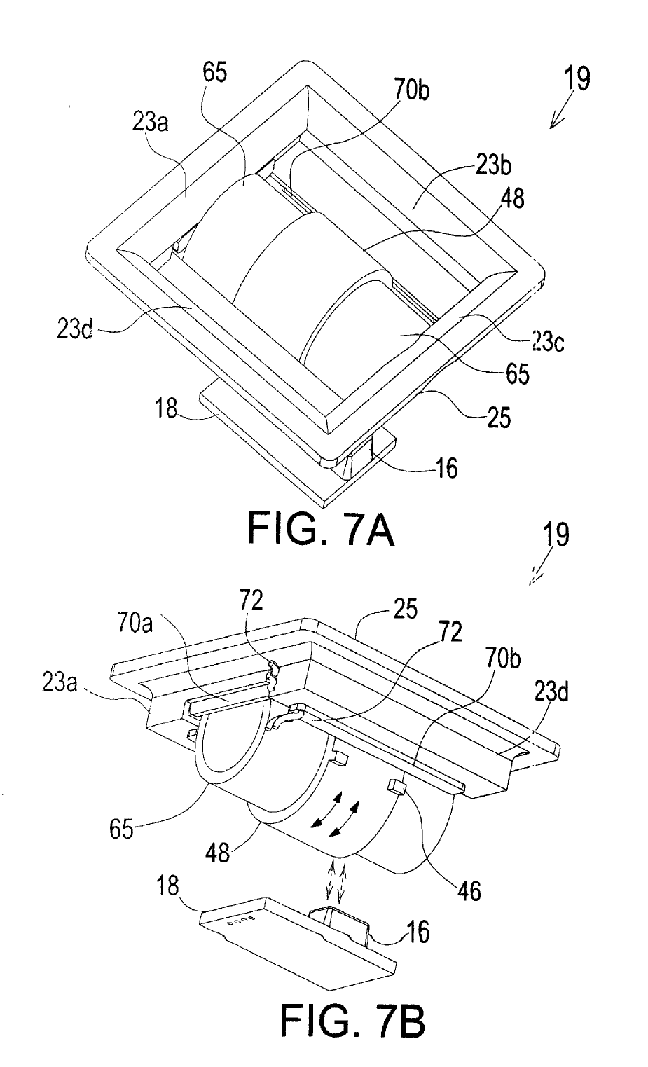

A control unit 19 comprising a movable ring element 48 is mounted over a stationary cylindrical tube 65 provided within a frame 25 having side portions 23a/b/c/d which are wired with integrated pressure sensors 70 (see FIG. 7B) operable in conjunction with an optical sensor 16 (see FIG. 5) mounted externally to ring element 48. A stopper 46 (see FIG. 7B) formed on ring element 48 tangentially contacts a pressure sensor (not shown) mounted on either side portion 23b or 23d of frame 25 when ring element 48 is rotated to perform a variety of pointer-related command instructions as are known to those skilled in the art. Alternatively, a user interface, such as standard control buttons 74 or a keyboard 53 are provided for carrying out control and pointing functions.

FIG. 7A shows a top perspective view of the control unit of FIG. 6 disposed within a frame 25. Side portions 23a/b/c/d conceal and support pressure sensors 70 (see FIG. 7B) mounted below side portions 23a/b/c which are activated when ring element 48 is rotated or slid over stationary cylindrical tube 65 so as to come into pressure contact with a pressure sensor 70a/b/c/d (see FIG. 7B). An optical sensor 16 communicates motion data of the movement of ring element 48 to a central processing unit (not shown) for operating a cursor or performing pointing functions and is synchronized to work smoothly with the data collected from pressure sensors 70a/b/c/d.

FIG. 7B shows a bottom perspective view of the embodiment of FIG. 7A.

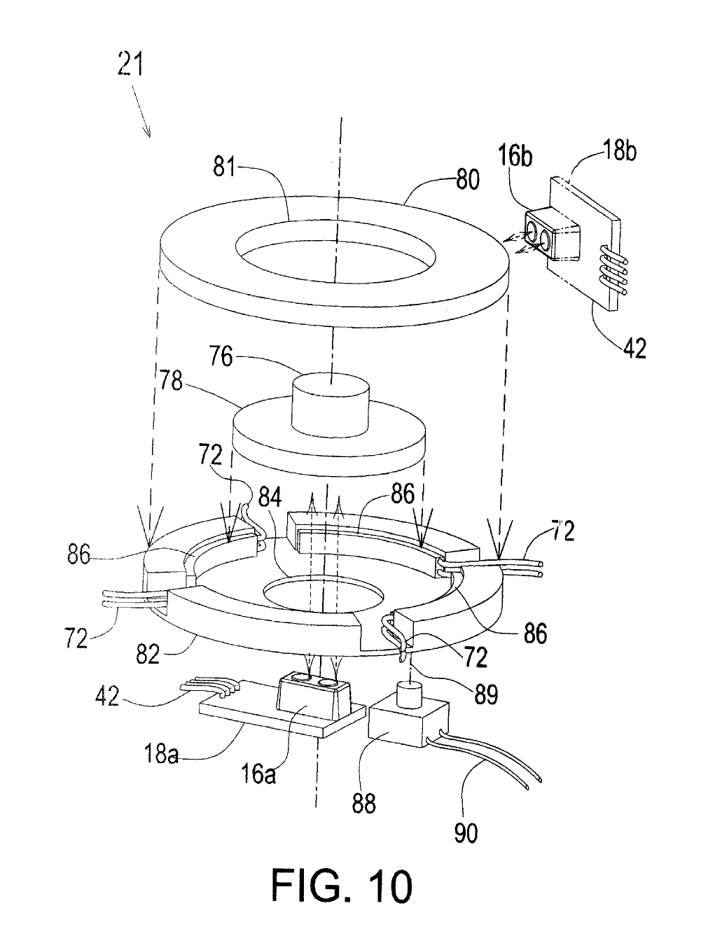

Cylindrical tube 65 with ring element 48 is shown mounted within frame 25. Side portions 23a/b/c/d are mounted beneath frame 25, but in contact with pressure sensors 70 (only two are visible in FIG. 7B). For example, when ring element 48 is rotated over cylindrical tube 65 as indicated by the two curved arrows, stopper 46 contacts pressure sensor 70b. Conversely, when ring element 48 is rotated in the opposite direction, stopper 46 contacts pressure sensor 70d (not visible) under side portion 23d. The pressure of such contact on the respective side portions 23d and 23b is interpreted by a CPU (see FIG. 10) and generates information usable for various control functions of a remote-control pointing device, such as, for example, change of speed of cursor movement, and other predetermined commands.

These pressure sensors 70 are designed to be responsive to coarse movements, whereas optical sensor 16 is sensitive to fine movements. Both an optical senior 16, for location data, and one or more pressure sensors 70, for speed and direction related to motion data, share location information from a common register within the CPU so that they work synergistically together, and transition of control from one to the other is seamless.

Such a limitation on the rotation of movable ring element 48 makes it ideal for use in smaller, hand-held pointer devices such as cellular phones, remote control devices for machinery, and the like, where unlimited rotation might be unnecessary or undesirable due to the constraints of space on the body surface of a remote-control pointing device for accommodating the inventive control unit.

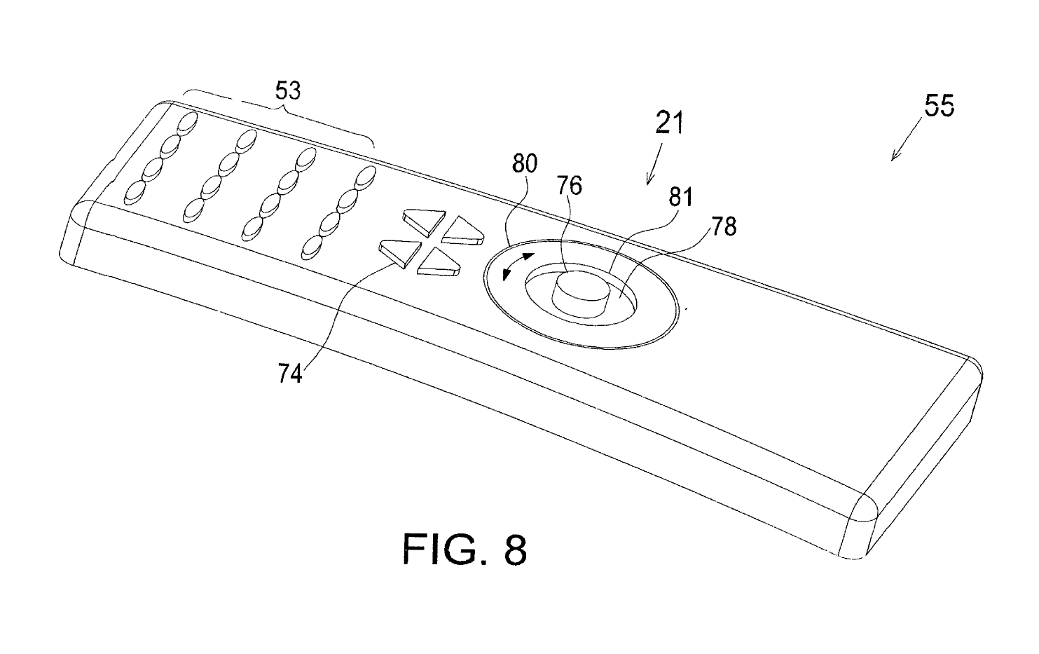

FIG. 8 shows a general perspective view of yet another embodiment of a control unit 21 constructed in accordance with the principles of the present invention, comprising a movable flat disk 78 with a finger-operated knob 76, shown incorporated into a conventional remote-control pointing device 55.

Control unit 21 comprises a movable flat disk 78 with a finger-operated knob 76, and framed within a ring frame 80 which can also rotate and acts as mother control switch when incorporated in a conventional type remote control pointing device 55. The inner circumference 81 of ring frame 80 serves as a continuous surface for activating pressure sensors (see FIG. 10) which are strategically mounted proximate to and around the circumference 81. When knob 76 is moved by finger action to make pressure contact with ring frame 80, a pressure sensor 86 is activated for performing control or navigational operations.

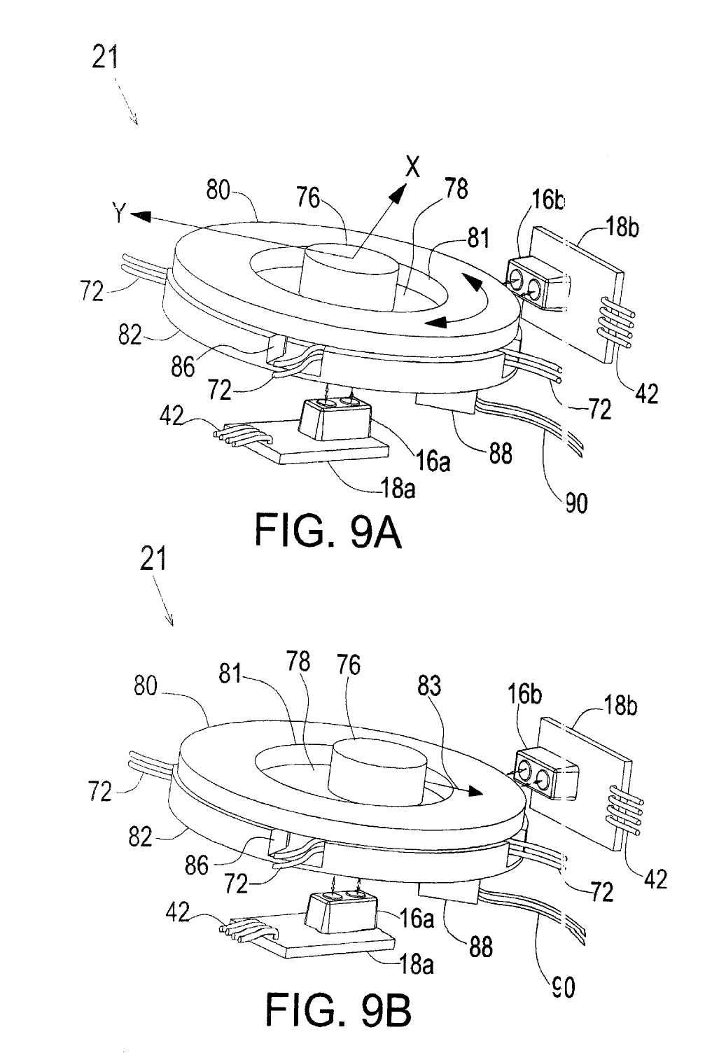

Pressure sensors 86 are in communication with a CPU (not shown) which not only collects location and movement data, but also synchronizes data collected from optical sensors 16 (see FIGS. 9a/b) for smooth interoperability of movements and commands applied to a common distant target, such as a cursor on a display screen.

Control unit 21 is shown incorporated in a conventional remote-control pointing device 55. Note the option to provide a user interface, such as pushbuttons 53 and/or additional control buttons 74 which give pointing device 55 many features applicable in a variety of situations and make it a universal type pointing device. The functions of different kinds of pointing devices can all be incorporated into one device making pointing device 55 both efficient and economical.

FIGS. 9A and 9B illustrate, in detail, the features of finger-operated control unit 21 of FIG. 8.

FIG. 9A shows a general perspective view of the movable flat disk element 78 illustrating the ease of movement in both X and Y directions of motion (indicated by vectors X, Y). Note that rotation of ring frame 80 in one direction initiates movement of a cursor in a vertical direction (up or down), whereas a counter-rotation of ring frame 80 initiates movement in the other direction (down or up, respectively). This control allows mirroring cursor movements on a screen display in multiple spatial directions when taken together with the X and Y direction data collected by an optical sensor 16a mounted on base 18a and in communication with a CPU (not shown). A first optical sensor 16a is disposed under base 82 to detect movement in the plane of the reflective bottom surface of flat disk 78. A second optical sensor 16b mounted on base 18b detects rotational motion of a reflective edge of ring frame 80 for implementing predetermined control and pointing functions.

FIG. 9B shows a general perspective view of control unit 21 of FIG. 9A illustrating a rightward shift in position of flat disk 78 as indicated by arrow 83. This action results in pressure contact with one of the pressure sensors 86 to activate a pointing or control function as predetermined by the system. Movable disk 78 is easily moved along X and Y vectors by an ergonomic, one-finger action, such as thumb control.

FIG. 10 is a detailed exploded view showing the components of the flat disk embodiment of control unit 21 of FIGS. 9A and 9B.

Ring frame 80 has an inner circumference 81 to accommodate the height of knob 76 when control unit 21 is assembled so as to allow grasping and manipulating knob 76 for implementing control and pointing functions.

Inner circumference 81 is shaped so as to loosely accommodate knob 76 and allow it a degree of freedom of movement for manipulating flat disk 78 in any direction on the surface of a supporting base 82. Movement of flat disk 78 is confined within the space defined by the presence of one or more pressure sensors 86 arranged in close proximity to the inner circumference of supporting base 82 in a circle whose diameter is greater than that of flat disk 78. This allows flat disk 78 to have sufficient room to maneuver while taking into account making pressure contact with pressure sensors 86 when necessary for signaling predetermined control or pointing functions with respect to a remote target, such as, for example, navigating a cursor on a display screen.

Knob 76 is used to guide flat disk 78 over base 82, which, in relation thereto, is stationary. Supporting base 82 is provided with an aperture 84 to allow an optical sensor 16a mounted on a stationary base 18a to “view” lateral and forward or backward motion of points on the reflective underside surface of flat disk 78.

Another optical sensor 16b mounted on a base 18b and disposed in close proximity to one edge of ring frame 80 detects its rotation in either clockwise or counterclockwise directions for depth control of a virtual pointer, such as a cursor, on a display screen in a third vector perpendicular to the plane of flat disk 78.

An optional control switch 88 is disposed just under one edge of supporting base 82 to control double or single click operations much like the “left” button of a conventional mouse pointer. It is activated by a heavier tilting pressure applied to knob 76 by a finger of a user which causes flat disk 78 to engage control switch 88. In a preferred embodiment of the present invention, control switch 88 is a toggle switch, but other switches which can similarly activate this function may be used.

When the pressure sensors 86 and optical sensors 16 are connected to a power source (such as battery—not shown) and activated, control unit 21 provides multiple command and navigation potential for a remote-control pointing device through a synergistic combination of one or more pressure sensors and optical sensors and the data they collect.

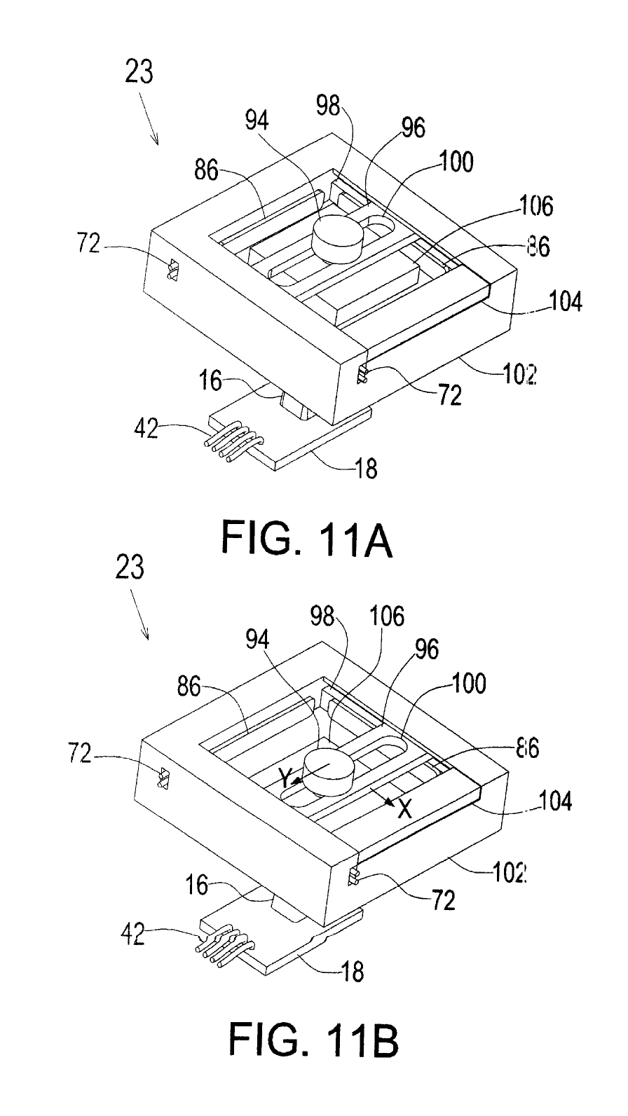

FIGS. 11A and 11B show yet another embodiment of the present invention utilizing a control unit 23 having a sliding control element 96 and a slidable-knob 94 for controlling pointing functions in a remote target location.

Control unit 23 is housed in housing block 102 for accommodating a sliding base plate 106 connected to a control knob 94 and a sliding control element 96. Sliding control element 96 is movable in an X direction (see FIG. 11B) within guide grooves 98 formed in housing block 102 to accommodate and support each end of sliding control element 96. Sliding knob 94 connected to sliding base plate 106 is movable in a Y direction (see FIG. 11B) within a slot 100 formed in sliding control element 96 so that all points within a predefined planar surface bounded by housing block 102 are reachable. Pressure sensors 86 are disposed around the inner sides of housing block 102 to provide pressure contact with base 86 by manipulation of slidable knob 94. Pressure contact with any pressure sensor 86 is communicated by cables 72 to a CPU (not shown) and the data interpreted to operate predetermined control and pointing functions.

An optical sensor 16 mounted on a base 18 and connected by cable 42 to the operating CPU (not shown) detects the movement of points on the reflective undersurface of slidable base plate 106 when control knob 94 is moved. This information is also communicated to the CPU for implementing control and pointing functions in smooth interaction with the data collected from pressure sensors 86.

Control unit 23 comprises a housing block 102 provided with a removable locking piece 104 for disassembly of the movable portions if the need arises.

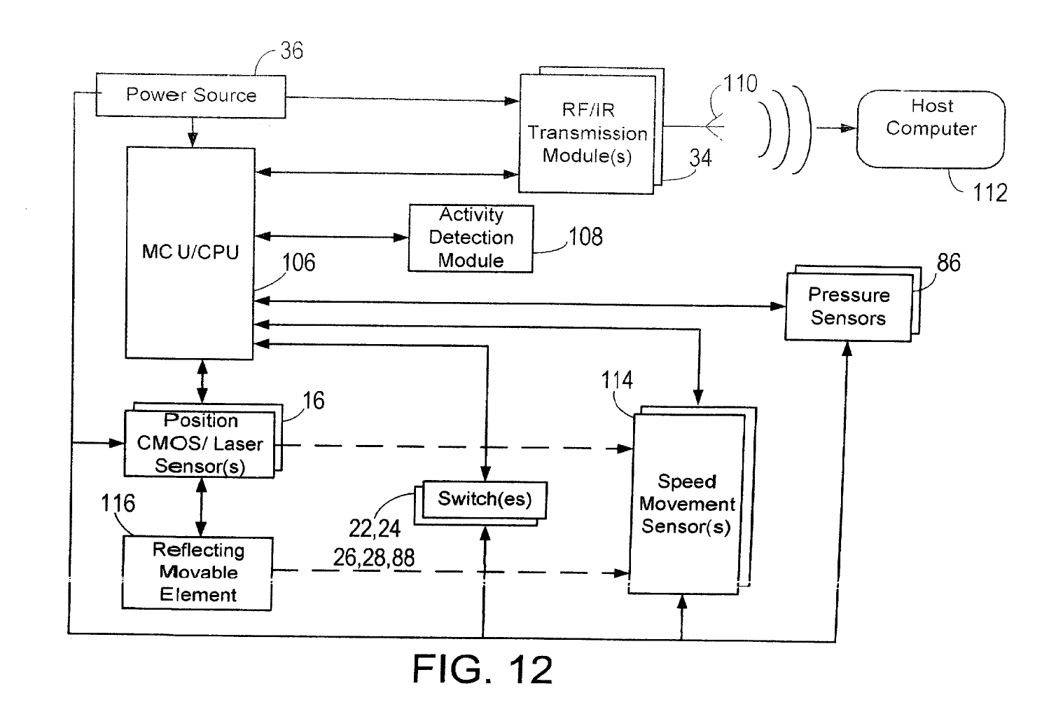

FIG. 12 is a block diagram of the general system of the present invention in accordance with the principles thereof.

A Central Processing Unit (CPU) 106 (or, alternatively, a Master Computing Unit—MCU) is the processing element which controls the operation and functions of many sub-units and elements within the system of the present invention. There is provided at least one position CMOS/laser sensor 16, such as optical sensor 16 (see FIG. 2) which receives information from the surface of a reflecting movable control element 116, such as ring element 12 in FIG. 1, or flat disk 78 in FIG. 8.

The MCU/CPU 106 is in communication with an activity detection module 108 for detecting motion of, for example, ring element 12 and converting such information into position data for the system to control, for example, the position of a cursor on a display screen. Both a plurality of pressure sensors 86 and at least one speed movement sensor 114 feed data into the MCU/CPU 106 for interpretation and control functions. A number of switches 22, 24, 26, 28, and 88 provide additional user input for the MCU/CPU 106 for control or navigational management.

The data collected and processed by MCU/CPU 106 is transmitted by at least one data transmitter element, such as represented by RF/IR transmission module 34 via an antenna 110 to a host computer 112 which provides a driver for the cursor movements and speed and direction of motion. In the embodiments of the present invention shown in FIGS. 1 and 3, the power source comprises at least one battery, but any suitable power source can be used to activate the device of the invention, including standard electrical wire connections to electrical plugs.

Having described the present invention with regard to certain specific embodiments thereof, it is to be understood that the description is not meant as a limitation, since further modifications may now suggest themselves to those skilled in the art, and it is intended to cover such modifications as fall within the scope of the appended claims.

We claim:

1. A control unit disposed in a portable, hand-held, remote-control pointing device for providing a control and pointing function, said control unit comprising:
a stationary element;
a movable control element having at least one reflective surface disposed proximate to said stationary element and arranged for motion with respect thereto for activating said control and pointing function;
at least one optical sensor fixedly disposed in close proximity to said movable control element to acquire location data by tracking relative motion with respect to said at least one reflective surface; and
at least one pressure sensor fixedly disposed in close proximity to said movable control element to detect pressure contact therewith and to collect associated contact data;
such that said at least one pressure sensor detects pressure contact when said movable control element is put into pressure contact therewith and collects said contact data enabling control and pointing functions associated with said pointing device without the need for an external, stationary reference surface.

2. The control unit of claim 1, wherein said stationary element comprises a cylindrical tube fixedly disposed within said pointing device.

3. The control unit of claim 1, wherein said stationary element comprises a base fixedly disposed within said pointing device.

4. The control unit of claim 1, wherein said movable control element comprises a rotatable and slidable ring.

5. The control unit of claim 4, wherein said rotatable and slidable ring is provided with an indentation formed therein suitable to accommodate a finger for guiding the movement and direction of motion of said rotatable and slidable ring.

6. The control unit of claim 1, wherein said movable control element is a sphere.

7. The control unit of claim 6, wherein said sphere is provided with an indentation formed therein suitable to accommodate a finger for guiding the movement and direction of motion of said sphere.

8. The control unit of claim 1, wherein said movable control element comprises:
a flat disk having a reflective underside and circumferential side edge and whose upper side is provided with a central knob suitable to accommodate a finger for guiding the movement and direction of motion of said flat disk;
a rotatable ring frame mounted over a lower circular base and having a central opening substantially larger than the diameter of said central knob protruding therefrom, said rotatable ring frame being disposed over said central knob to provide directional control for selection of predetermined pointing functions;
at least one pressure sensor disposed in the inner periphery of said lower circular base which is activated by pressure contact with said circumferential side edge of said flat disk when said movable control element is operated;
at least a first optical sensor disposed below said reflective underside surface of said flat disk for acquiring location data in two dimensions of movement of said flat disk when said flat disk is in motion; and
at least a second optical sensor disposed in close proximity to a reflective side edge of said rotatable ring frame for acquiring location data with respect to movement of said reflective side edge when said flat disk is in motion.

9. The control unit of claim 8, wherein said central knob is provided with an indentation formed therein suitable to accommodate a finger for manipulating said flat disk.

10. The control unit of claim 8, wherein said rotatable ring frame controls spatial navigation commands for an on-screen pointer by either of a clockwise and counterclockwise rotation of said rotatable ring frame when operated by a user.

11. The control unit of claim 1, wherein said movable control element comprises:
a housing block fixedly disposed within said pointing device;
a slotted, sliding control element being free to move within guide grooves formed in opposite sides of said housing block, said movement being in only one direction and in reverse thereto within a plane whose boundaries are demarked by the frame of said housing block;
a slidable base plate disposed within said housing block and having a reflecting bottom surface and a control knob mounted on an upper surface, said control knob being supported within the slot of said sliding control element, and constrained to move in only one direction and the reverse thereto perpendicular to said direction of said slotted, sliding bar; and
at least one optical sensor disposed in close proximity to said reflecting bottom surface and in visual contact thereto to detect movement of said reflecting bottom surface when said movable control element is operated.

12. The control unit of claim 11, wherein said control knob is provided with an indentation formed therein suitable to accommodate a finger for manipulating said flat base plate within said housing block.

13. The control unit of claim 1, further comprising a switch for providing a “left” click-type operating function.

14. The control unit of claim 1, further comprising a switch for providing a “right” click-type operating function.

15. The control unit of claim 1, wherein said movable control element comprises a slidable knob connected to a rectangular base having a reflective undersurface, said slidable knob being guided within a slidable slotted holder itself free to move within an articulated frame so that combined movement of both said slidable knob together with said connected rectangular base and said slidable slotted holder allows complete freedom of movement, within limits defined by said articulated frame, of said movable control element in a two dimensional plane.

16. The control unit of claim 1, wherein said movable control element is provided with a stopper capable of making pressure contact with said at least one pressure sensor to operate a control and pointing function.

17. The control unit of claim 1, wherein said at least one reflective surface comprises an inside surface of said movable control element.

18. The control unit of claim 1, wherein said at least one reflective surface comprises an outside surface of said movable control element.

19. The control unit of claim 1, wherein said at least one optical sensor collects location data through an exposure provided within said stationary element to detect motion of said movable control element.

20. The control unit of claim 19, wherein said exposure is an aperture provided in said stationary element disposed so as to be visually aligned with said at least one optical sensor.

21. The control unit of claim 19, wherein said exposure is an optically transparent surface portion formed in said stationary element and disposed so as to be visually aligned with said at least one optical sensor.

22. The control unit of claim 1, wherein said at least one optical sensor is sensitive to fine movements using said movable control element when said at least one optical sensor is activated, and said pressure sensor is sensitive to coarse movements when said at least one pressure sensor is activated, said at least one optical sensor and said at least one pressure sensor working synchronously.

23. The control unit of claim 1, wherein said remote-control pointing device comprises:
a movable control element;
a processing element for processing said location data from said at least one optical sensor and pressure contact data from said at least one pressure sensor; and
a data transmitter element for transmitting said location data and pressure contact data to a CPU to initiate at least one of a control and pointing function at a remote target location;
whereby when said remote-control pointing device is connected to a power source and said movable control element is moved relative to said stationary element, said at least one optical sensor measures the relative movement and location of said movable control element, while said at least one pressure sensor responds to pressure contact of said movable control element with said at least one pressure sensor to control predetermined navigational and operational commands, said location and command information being processed by said processing element and transmitted via said data transmitter element to said target location.

24. The control unit of claim 1, wherein said location data and said pressure contact data are transmitted to said processing element by wireless means.

25. The control unit of claim 24, wherein said wireless means is selected from at least one of the group comprising: infrared, laser, RFID, Bluetooth and the like.

26. The control unit of claim 23, wherein said data transmitter element is wire-connected to an external processor.

27. A system for remote-control and pointing functions, said system comprising:
a control unit having a movable control element and disposed in a remote-control pointing device provided with at least one optical sensor and at least one pressure sensor;
a processing element for processing location data from said at least one optical sensor and pressure contact data from said at least one pressure sensor; and
a data transmitter element for transmitting said location data and pressure contact data to a target location;
such that when said remote-control pointing device is connected to a power source and said movable control element is moved relative to said pointing device, said at least one optical sensor measures the relative movement and location of said movable control element, while said at least one pressure sensor responds to pressure contact of said movable control element therewith to control predetermined control and pointing functions without the need for an external, stationary reference surface, said location and command information being processed by said processing element and transmitted via said data transmitter element to said target location.

28. The system of claim 27, wherein said control unit comprises:
a stationary element;
a movable control element having at least one reflective surface disposed proximate to said stationary element and arranged for motion with respect thereto for activating said control and pointing function;
at least one optical sensor fixedly disposed in close proximity to said movable control element to acquire location data by tracking relative motion with respect to said at least one reflective surface; and
at least one pressure sensor fixedly disposed in close proximity to said movable control element to detect pressure contact therewith and to collect associated contact data;
such that said at least one pressure sensor detects pressure contact when said movable control element is put into pressure contact therewith and collects said contact data enabling control and pointing functions associated with said pointing device without the need for an external, stationary reference surface.
